(19) United States
(12) Patent Application Publication
(10) Pub. No.: US 2015/0243401 A1
(43) Pub. Date: Aug. 27, 2015

(54) CONDUCTOR, AND ELECTRIC WIRE AND CABLE USING THE SAME

(71) Applicant: Hitachi Metals, Ltd., Tokyo (JP)

(72) Inventors: Keisuke FUJITO, Mito (JP); Hideyuki SAGAWA, Naka-gun (JP); Toru SUMI, Hitachi (JP)

(21) Appl. No.: 14/597,699

(22) Filed: Jan. 15, 2015

(30) Foreign Application Priority Data
Feb. 26, 2014 (JP) 2014-035766

(51) Int. Cl. H01B 1/02

(52) U.S. Cl. CPC H01B 1/026

(57) ABSTRACT

A conductor includes a copper alloy including crystal grains. The crystal grains include a first crystal grain group having a grain size larger than a predetermined standard grain size and a second crystal grain group having a grain size smaller than the predetermined standard grain size. The crystal grains have a local maximum value of grain size distribution in each of the first crystal grain group and the second crystal grain group.

The present application is based on Japanese patent application No. 2014-035766 filed on Feb. 26, 2014, the entire contents of which are incorporated herein by reference.

### BACKGROUND OF THE INVENTION

1. Field of the Invention

This invention relates to a conductor, and an electric wire and a cable using the conductor.

2. Description of the Related Art

A conductor formed by being subjected to wire drawing is used for a cable such as an acoustic equipment cable. For the material of the conductor, for example, a copper alloy such as a Tough Pitch Copper (TPC), an Oxygen Free Copper (OFC), a Pure Copper having purity of 99.9999% (6N copper), a Linear Crystalline Oxygen Free Copper (LC-OFC), a Pure Copper Ohno Continuous Casting process (PCOCC) corresponding to a single crystalline oxygen free copper is used (see e.g. JP-A-2002-363668 and JP-A-H10-280113).

For the purpose of enhancing sound quality when an electric signal transmitted through an acoustic cable is output, the conductor is needed to have a high electric conductivity. Generally, since impurities (for example, oxygen, sulfur and so on) contained in the copper alloy that constitutes the conductor are little, there is a tendency that the electric conductivity of the conductor becomes high in proportion to the grain size of the crystal grain that constitutes the copper alloy. In case of the TPC, the OFC, the 6N copper, the LC-OFC, the PCOCC or the like, the grain size of the crystal grain is increased in this order, thus the 6N copper, the LC-OFC and the PCOCC are excellent in electric conductivity. Consequently, from the view point of enhancing the sound quality of the acoustic device cable, the 6N copper, the LC-OFC, the PCOCC and the like are suitable.

### SUMMARY OF THE INVENTION

The conductor is further needed to have a high strength together with a high electric conductivity in terms of preventing breaking of wire. It is known that generally in the copper alloy, the more the size of the crystal grain constituting the copper alloy is reduced, the more the strength may be increased, and the more the size of the crystal grain is increased, the more the strength may be reduced.

Thus, where the conductor is formed of the TPC, the OFC or the 6N copper, it is difficult to have both high electric conductivity and high strength. In particular, there is a tendency that the conductor formed of the TPC or the OFC has small crystal grains, thus the electric conductivity is reduced, but the strength is increased. To the contrary, there is a tendency that the conductor formed of the 6N copper has large crystal grains, thus the electric conductivity may be increased, but the strength may be reduced.

On the other hand, the conductor formed of the LC-OFC or the PCOCC is a hard drawn copper wire constituted of the crystal grain that is elongated in the extension direction of the conductor, and to which processing strain is further applied, whereby both the high electric conductivity and the high strength can be obtained. However, since the conductor formed of the LC-OFC or the like is the hard drawn copper wire, a problem may arise that it has only such a low elongation as to be easily broken. Meanwhile, the conductor formed of the LC-OFC or the like can be annealed so as to be processed into a soft copper wire to improve the elongation, but due to the annealing the characteristic crystal structure collapses by recrystallization so that the conductor will be a conductor formed of OFC in which a large number of crystal grain boundaries exist in the signal transmission direction. Namely, where the conductor formed of the LC-OFC or the like is processed into the soft copper wire, the inherent electric conductivity may be lost.

Thus, where the conductor is formed of the TPC, the OFC, the 6N copper, the LC-OFC or the PCOCC, it is difficult to have both high electric conductivity and high strength even if it is processed into the soft copper wire so as to improve the elongation.

It is an object of the invention to provide a conductor that has both the high electric conductivity and the high strength in addition to the sufficient elongation, as well as an electric wire and a cable using the conductor.
(1) According to one embodiment of the invention, a conductor comprises a copper alloy comprising crystal grains,

wherein the crystal grains comprise a first crystal grain group having a grain size larger than a predetermined standard grain size and a second crystal grain group having a grain size smaller than the predetermined standard grain size, and

wherein the crystal grains have a local maximum value of grain size distribution in each of the first crystal grain group and the second crystal grain group.

### Effects of the Invention

According to one embodiment of the invention, a conductor can be provided that has both the high electric conductivity and the high strength in addition to as the sufficient elongation, as well as an electric wire and ,a cable using the conductor.

### BRIEF DESCRIPTION OF THE DRAWINGS

The preferred embodiments according to the invention will be explained below referring to the drawings, wherein:

FIG. 1A is a SEM image showing a cross section perpendicular to the extension direction in a conductor according to one embodiment of the invention;

FIG. 1B is a schematic diagram of the SEM image of FIG. 1A;

FIG. 2 is a graph showing a grain size distribution of the conductor according to one embodiment of the invention;

FIG. 3 is a graph showing a grain size distribution of a conductor according to the other embodiment of the invention;

FIG. 4 is a graph showing a grain size distribution of a conductor according to the other embodiment of the invention;

FIG. 5 is a graph showing a grain size distribution of a conductor according to the other embodiment of the invention;

FIG. 6 is a SEM image showing a cross section perpendicular to the extension direction in a conventional conductor comprised of OFC;

FIG. 7 is a graph showing a grain size distribution of the conventional conductor comprised of the OFC;

FIG. 8 is a SEM image showing a cross section perpendicular to the extension direction in a conventional conductor comprised of 6N copper;

FIG. 9 is a graph showing a grain size distribution of the conventional conductor comprised of the 6N copper; and

FIG. 10 is a cross-sectional view schematically showing an acoustic device cable according to one embodiment of the invention;

### DETAILED DESCRIPTION OF THE PREFERRED EMBODIMENTS

As mentioned above, in case of the conventional conductor, it is difficult to realize both high electric conductivity and high strength as the soft copper wire. With regard to this point, the inventors et al. have studied the respective conductors comprised of the OFC and the 6N copper as the soft copper wire while paying attention to a grain size distribution of a crystal grain constituting the copper alloy of the conductor.

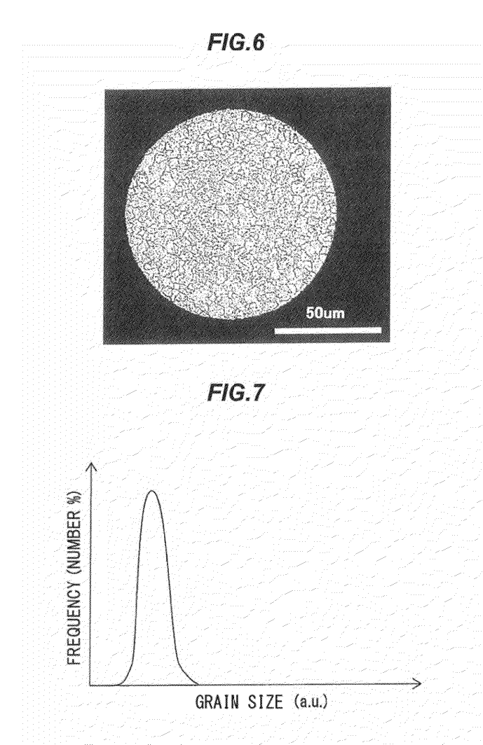

FIG. 6 shows a cross section (hereinafter referred to as “transverse section”) perpendicular to the extension direction with regard to a conductor (diameter of 0.1 mm) comprised of the OFC. A grain size of a crystal grain constituting the OFC has been measured from FIG. 6, then it has been confirmed that the grain size of the crystal grain falls within the range of not less than 2 μm and not more than 5 μm. In addition, a grain size distribution of a crystal grain constituting a crystal structure of the OFC has been measured, then as shown in FIG. 7, it has been confirmed that the grain size distribution of the OFC has one maximum value in the range of not less than 2 μm and not more than 5 μm. For this reason, it is known that the OFC is configured to mainly include the crystal grain of which grain size falls within the range of not less than 2 μm and not more than 5 μm, and in the crystal structure, the crystal grains having a small grain size are distributed uniformly.

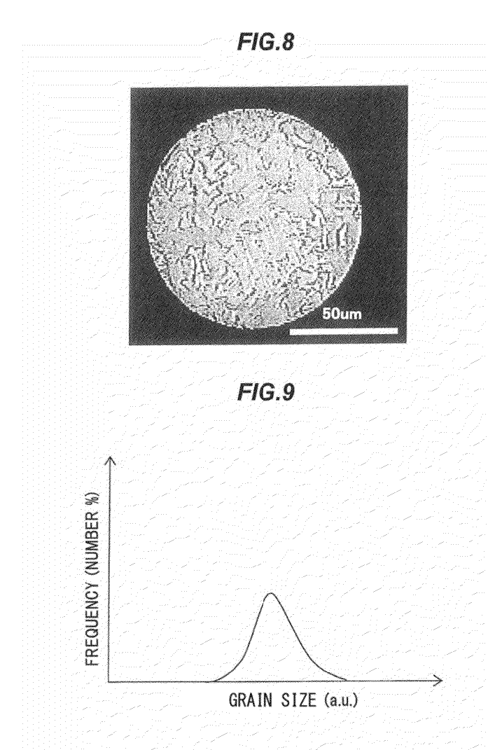

FIG. 8 shows a transverse section with regard to a conductor (diameter of 0.1 mm) comprised of the 6N copper. A grain size of a crystal grain constituting the 6N copper has been measured from FIG. 8, then it has been confirmed that the grain size of the crystal grain falls within the range of not less than 8 μm and not more than 20 μm. In addition, a grain size distribution of a crystal grain constituting a crystal structure of the 6N copper has been measured, then as shown in FIG. 9, it has been confirmed that the grain size distribution of the 6N copper has one maximum value in the range of not less than 8 μm and not more than 20 μm. For this reason, it is known that the 6N copper is configured to mainly include the crystal grain of which grain size falls within the range of not less than 8 μm and not more than 20 μm, and in the crystal structure, the crystal grain having a relative large grain size is distributed uniformly.

As mentioned above, the OFC has small crystal grains in the crystal diameter, thus the OFC has a tendency to be low in the electric conductivity, but to be high in the strength. On the other hand, the 6N copper has large crystal grains in the crystal diameter, thus the 6N copper has a tendency to be high in the electric conductivity, but to be low in the strength. Namely, the copper alloy has different electric conductivity and strength according to the grain size of the crystal grain constituting the copper alloy. Hereinafter, a relationship between the grain size of the crystal grain and the electric conductivity, and a relationship between the grain size of the crystal grain and the strength are particularly explained.

The relationship between the grain size of the crystal grain and the electric conductivity can be explained as follows. Generally, the copper alloy has a crystal structure constituted of the crystal grain of copper. In case that the grain size of the crystal grain is small, the crystal structure becomes fine, to the contrary, in case that the grain size of the crystal grain is large, the crystal structure becomes coarse. A boundary between the crystal grains (so-called crystal grain boundary) exists in the crystal structure, and in case that the crystal structure is fine, the crystal grain boundary is increased in number, and in case that the crystal structure is coarse, the crystal grain boundary is reduced in number. The crystal grain boundary scatters an electric signal transmitting through the copper alloy so as to attenuate the electric signal, thus it becomes a factor for reducing the electric conductivity of the copper alloy. Consequently, in the copper alloy having small crystal grains in the grain size and having a fine crystal structure such as the OFC, the crystal grain boundary is increased in number, thus the electric conductivity is reduced. On the other hand, in the copper alloy having large crystal grains in the grain size and having a coarse crystal structure such as the 6N copper, the crystal grain boundary is decreased in number, thus the electric conductivity is increased.

In addition, the relationship between the grain size of the crystal grain and the strength can be explained as follows. In the conductor formed by being subjected to wire drawing process of the copper alloy, the crystal grain constituting the conductor is elongated in the extension direction of the conductor due to tensile deformation in the wire drawing process, thus the size of the crystal grain in the transverse section of the conductor is reduced. Then, strain in association with the tensile deformation occurs in the crystal grain. After that, when the conductor is recrystallized by that heat energy such as annealing is applied thereto, the crystal grain boundary is formed and fine crystal grain is formed. In the copper alloy such as the OFC having small crystal grains in the grain size and having a fine crystal structure, the recrystallization is finished in a state that the crystal grain boundary is increased in number, thus the crystal diameter of the crystal grain is maintained to be relatively small. In the copper alloy having fine crystal structure, the strength is increased. On the other hand, in the copper alloy such as the 6N copper having large crystal grains in the grain size and having a coarse crystal structure, the crystal grain is easily grown due to recrystallization, and after the recrystallization, the crystal grain boundary is reduced in number. Consequently, in the copper alloy having coarse crystal structure, the strength is reduced. Further, the relationship between the size of the crystal grain and the strength is generally known as Hall-Petch relation.

From the above, the OFC, the 6N copper and the like are configured such that the grain size distribution of the crystal grain has only one maximum value, and includes only any one of the crystal grain having relatively large grain size and the crystal grain having relatively small grain size. For this reason, in the OFC, the 6N copper and the like, only either one characteristic (electric conductivity or strength) of the crystal grain having large grain size and the crystal grain having small grain size is obtained, thus it is difficult to realize both high electric conductivity and high strength.

Accordingly, the inventors et al. have formed a copper alloy configured such that the grain size distribution of the crystal grain has not less than two maximum values, and the crystal grain having relatively large grain size and the crystal grain having relatively small grain size are mixed so as to study the copper alloy. As a result, it has been found that according to the conductor including the copper alloy, characteristics due to the respective crystal grains can be obtained and both high electric conductivity and high strength can be realized. The invention has been completed based on the above-mentioned knowledge.

### One Embodiment of the Invention

Hereinafter, one embodiment of the invention will be explained.

### (Acoustic Device Cable)

An approximate configuration of a cable according to one embodiment of the invention will be explained. Further, in the embodiment, an acoustic device cable will be explained as a cable.

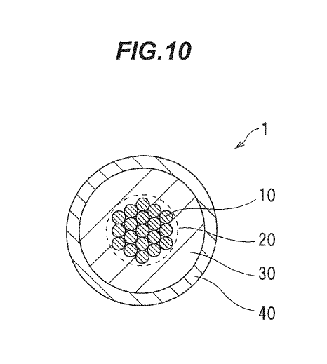

As shown in FIG. 10, the acoustic device cable 1 includes a stranded conductor 20 constituted of conductors 10, an insulating coating 30 disposed on the outer periphery of the stranded conductor 20, and a protective covering 40 disposed on the outer periphery of the insulating coating 30. The stranded conductor 20 is formed by twisting together a plurality of the conductors 10. The insulating coating 30 and the protective covering 40 are comprised of a known resin.

### (Conductor)

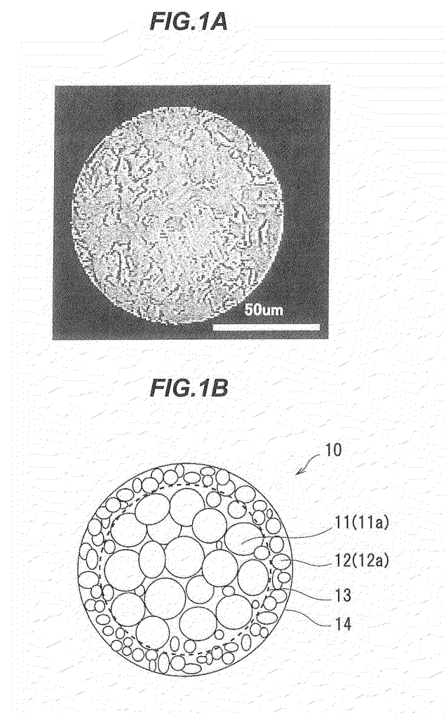

The conductor 10 according to the embodiment is formed by that a copper alloy is linearly extended. As shown in FIGS. 1A and 1B, the conductor 10 has a crystal structure constituted of the crystal grains of copper in the cross section (hereinafter referred to as “transverse section”) perpendicular to the extension direction. The crystal grains constituting the crystal structure of the conductor 10 have various grain sizes, and include a first crystal grain group 11 that is constituted of crystal grains having a grain size larger than a predetermined standard grain size and a second crystal grain group 12 that is constituted of crystal grains having a grain size smaller than the predetermined standard grain size, and have the maximum value of grain size distribution in each of the first crystal grain group 11 and the second crystal grain group 12.

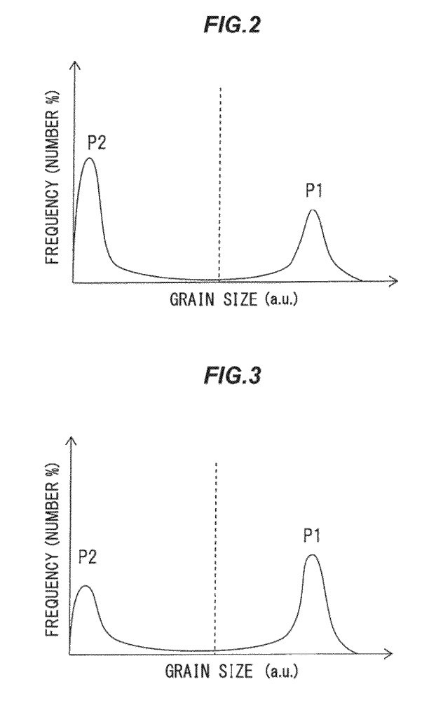

Here, the grain size distribution will be explained. The grain size distribution in the embodiment is a grain size distribution based on the number, and is an index showing that the crystal grain groups include the crystal grains of what grain size and in what rate. In particular, as shown in FIG. 2, the grain size distribution is configured such that the horizontal axis is taken as the grain size (arbitrary unit (a.u.)) of the crystal grain and the vertical axis is taken as the frequency (number ratio (number %)) of the crystal grain. The number ratio shows a ratio of the crystal grain having a predetermined grain size to the whole of crystal grains. In the grain size distribution, according to the distribution of the grain size of the crystal grain group, a part (peak) is formed, the part (peak) being configured to rise in a mountain shape in which the number ratio is heightened in a certain range of the grain size. The top of the peak constitutes the maximum value. In case that the crystal grain group has the maximum value of the grain size distribution, the crystal grain group has the peak of the grain size distribution, and in the crystal grain group, the number ratio of the crystal grain having the grain size corresponding to the peak is increased.

As shown in FIG. 2, the grain size distribution of the crystal grain constituting the conductor 10 is configured such that each of the first crystal grain group 11 that is constituted of crystal grains having a grain size larger than a predetermined standard grain size and the second crystal grain group 12 that is constituted of crystal grains having a grain size smaller than the predetermined standard grain size has the maximum value. Namely, the first crystal grain group 11 and the second crystal grain group 12 mainly exist in the conductor 10, and the other crystal grains having a grain size different from the grain groups 11, 12 exist in a trace amount. The other crystal grains include, for example, a crystal grain having a grain size intermediate between the first crystal grain group 11 and the second crystal grain group 12. Further, the predetermined standard grain size means, for example, the center value of the minimum grain size and the maximum grain size of the crystal grains constituting the conductor 10 (in FIGS. 2 to 5, the standard grain size is shown by a broken line).

As shown in FIG. 2, the first crystal grain group 11 has a peak P1 on the side of the grain size larger than the predetermined standard grain size in the grain size distribution and has the maximum value. When the crystal grain having the grain size corresponding to the peak P1 is defined as a first crystal grain 11a, the first crystal grain group 11 mainly includes the first crystal grain 11a having the grain size larger than the predetermined standard grain size, and includes the crystal grain having a grain size other than the above-mentioned grain size in a trace amount. Namely, the ratio of the first crystal grain 11a to the crystal grains included in the first crystal grain group 11 is large, and the number ratio is large. Consequently, the first crystal grain group 11 mainly includes the first crystal grain 11a having a relatively large grain size so that it can reduce the crystal grain boundary in the crystal structure of the conductor 10 and enhance the electric conductivity of the conductor 10.

As shown in FIG. 2, the second crystal grain group 12 has a peak P2 on the side of the grain size smaller than the predetermined standard grain size in the grain size distribution and has the maximum value. When the crystal grain having the grain size corresponding to the peak P2 is defined as a second crystal grain 12a, the second crystal grain group 12 mainly includes the second crystal grain 12a having the grain size smaller than the predetermined standard grain size, and includes the crystal grain having a grain size other than the above-mentioned grain size in a trace amount. Namely, the ratio of the second crystal grain 12a to the crystal grains included in the second crystal grain group 12 is large, and the number ratio is large. Consequently, the second crystal grain group 12 mainly includes the second crystal grain 12a having a relatively small grain size so that it can enhance the strength of the conductor 10. In addition, it can increase the crystal grain boundary in the crystal structure of the conductor 10 so as to reduce processing strain in the conductor 10 by dispersion, so that it can prevent breaking of wire when the conductor 10 is bent.

As shown in FIG. 1B, the first crystal grain group 11 and the second crystal grain group 12 are mixed and distributed. In particular, the first crystal grain group 11 that is constituted of crystal grains having a large grain size is distributed in the center region 13 in the diameter direction of the transverse section, and the second crystal grain group 12 that is constituted of crystal grains having a small grain size is distributed in the outer periphery region 14 surrounding the center region 13. The center region 13 is constituted of the first crystal grain group 11 that is constituted of crystal grains having a large grain size, thus the crystal grain boundary is relatively small in number. The outer periphery region 14 is constituted of the second crystal grain group 12 that is constituted of crystal grains having a small grain size, thus the crystal grain boundary is relatively large in number. As mentioned above, the conductor 10 is configured such that in the center region 13, the crystal grain boundary is relatively small in number, and in the outer periphery region 14, the crystal grain boundary is relatively large in number. The more the crystal grain boundary is large in number, the more the electric signal is easily attenuated, thus in the center region 13 (inner part) of the conductor 10, attenuation in the electric signal is reduced, and in the outer periphery region 14 (front surface), attenuation in the electric signal is increased. The above-mentioned conductor 10 is used in the acoustic device cable 1, thereby the sound quality of the acoustic device cable 1 can be further enhanced. Further, the first crystal grain group 11 is mainly distributed in the center region 13, but it may be distributed in the outer periphery region 14 in a trace amount. In addition, similarly, the second crystal grain group 12 is mainly distributed in the outer periphery region 14, but it may be distributed in the center region 13 in a trace amount.

The copper alloy constituting the conductor 10 is configured such that impurities are contained therein and the concentration of the impurities in the outer periphery region 14 is higher than that in the center region 13. As mentioned below, these impurities are inevitable impurities contained in the copper alloy, and deposited products (crystallized products) generated by reaction with additive elements. These crystallized products are distributed in the outer periphery region 14 larger in number than the center region 13, thereby in the center region 13, the first crystal grain group 11 that is constituted of crystal grains having a large grain size is distributed, and in the outer periphery region 14, the second crystal grain group 12 that is constituted of crystal grains having a small grain size is distributed.

It is preferable that the outer periphery region 14 is a region located at the depth of not less than 5% and not more than 20% of the outer diameter of the conductor 10 from the surface of the conductor 10. For example, in case that the conductor 10 has an outer diameter of 100 μm, the outer periphery region 14 is a region located at the depth of not less than 5 μm and not more than 20 μm from the surface of the conductor 10.

In the embodiment, the grain size distribution of the first crystal grain group 11 has the maximum value preferably in a region of not less than 20 μm and more preferably in a region of not less than 25 μm and not more than 100 μm, and the grain size distribution of the second crystal grain group 12 has the maximum value preferably in a region of not more than 15 μm, and more preferably in a region of not less than 3 μm and not more than 10 μtm. Thereby, the first crystal grain group 11 further reduces the crystal grain boundary, thereby it can enhance the electric conductivity of the conductor 10. In addition, the second crystal grain group 12 further increases the crystal grain boundary, thereby it can enhance the strength of the conductor 10. Namely, each of the first crystal grain group 11 and the second crystal grain group 12 has the maximum value in the above-mentioned region of the grain size, thereby the electric conductivity and the strength obtained by each of the crystal grain groups can be further enhanced.

In addition, in the embodiment, the total value of the maximum value of the grain size distribution of the first crystal grain group 11 and the maximum value of the grain size distribution of the second crystal grain group 12 is preferably not less than 50%, and more preferably not less than 60% and not more than 90%. Each of the maximum values shows the number ratio of the first crystal grain 11a included in the first crystal grain group 11 and the number ratio of the second crystal grain 12a included in the second crystal grain group 12. If the maximum value is heightened, the number ratio of the first crystal grain 11a and the number ratio of the second crystal grain 12a are enlarged. The total value of the maximum value of the grain size distribution of the respective crystal grain groups is set within the above-mentioned range, thereby the ratio of the first crystal grain 11a and the number ratio of the second crystal grain 12a to the whole crystal grains included in the conductor 10 can be enhanced. Namely, the number ratio of crystal grains other than the first crystal grain 11a and the second crystal grain 12a, for example, the number ratio of the other crystal grains having a grain size intermediate between the first crystal grain 11a and the second crystal grain 12a can be reduced. Consequently, the electric conductivity and the strength obtained by the first crystal grain group 11 and the second crystal grain group 12 can be further enhanced.

In the embodiment, the maximum value of the grain size distribution of the first crystal grain group 11 is preferably not less than 10% and not more than 40%, and the maximum value of the grain size distribution of the second crystal grain group 12 is preferably not less than 40% and not more than 90%. Thereby, the total value of the maximum value of the grain size distribution of these grain groups can be set to be not less than 50%, and the electric conductivity and the strength obtained by the respective crystal grain groups can be further enhanced.

In addition, in the embodiment, each peak width of the first crystal grain group 11 and the second crystal grain group 12 is preferably within a grain size range of ±30%, and more preferably within the grain size range of ±10% centering on the grain size in the peak. If the peak width is within the above-mentioned range, the width of the peak is narrow so as to be a steep peak. Namely, variation of the grain size of the crystal grain in the respective crystal grain groups can be further reduced. Thereby, the electric conductivity and the strength obtained by the respective crystal grain groups can be further enhanced.

The copper alloy constituting the conductor 10 includes copper as a base material and additive elements, and the remnant is inevitable impurities.

As copper, if it contains a small amount of impurities, it is not particularly limited, but for example, a Low Oxygen Copper (LOC), an Oxygen Free Copper (OFC) and the like can be used.

As the additive element, it is preferable that at least one element selected from the group consisting of Ti, Mg, Zr, Nb, Ca, V, Ni, Mn and Cr is used. These additive elements reduce the inevitable impurities (oxygen, sulfur and so on) contained in copper so as to highly purify the copper alloy. Further, for example, in case that Ti is used as the additive element, compounds having a chemical bond such as TiO, TiO₂, TiS, Ti—O—S bond or aggregates thereof are generated. These compounds or aggregates are dispersed in the copper alloy.

The content of the additive element is not particularly limited, but it is preferably not less than 4 mass ppm and not more than 55 mass ppm, more preferably not less than 4 mass ppm and not more than 37 mass ppm, and further more preferably not less than 4 mass ppm and not more than 25 mass ppm. By using the above-mentioned content, the inevitable impurities can be reduced. In particular, the content of sulfur as the inevitable impurity is preferably not less than 3 mass ppm and not more than 12 mass ppm. In addition, the content of oxygen as the inevitable impurity is preferably more than 2 mass ppm and not more than 30 mass ppm.

The outer diameter of the conductor 10 is not particularly limited, but it is preferably not less than 0.05 mm and not more than 1 mm.

### (Manufacturing Method of Conductor)

Hereinafter, a method for manufacturing the above-mentioned conductor 10 will be explained.

### (Ingot Forming Process)

First, as copper, for example, a low oxygen copper having an oxygen concentration of not more than 20 mass ppm is prepared. The copper is melted at a temperature of, for example, not less than 1100 degrees C. and not more than 1320 degrees C. so as to form a molten metal of copper. Subsequently, for example, Ti of not less than 4 mass ppm and not more than 55 mass ppm as an additive element is added to the molten metal of copper so as to form a molten metal of copper alloy. At this time, Ti and inevitable impurities (sulfur S, oxygen O₂, and so on) contained in copper are reacted, thereby crystallized products such as TiS, TiO₂, or Ti—O—S compound are generated. Thereby, the inevitable impurities in copper can be reduced. Further, the crystallized products are dispersed in the molten metal of copper alloy. Subsequently, the molten metal of copper alloy is poured into a mold so as to be cooled and solidified, thereby an ingot of copper alloy is formed. Further, if the temperature of the molten copper is high, there is a tendency that a blow hole is increased, and in case of being formed as the conductor, a scratch occurs on the surface thereof and simultaneously the size of the crystal grain is increased, thus it is preferable that the temperature is controlled to not more than 1320 degrees C. In addition, the reason why the temperature of the molten metal is controlled to not less than 1100 degrees C. is because copper is easily coagulated and the manufacturing is not stable, but it is preferable that the temperature of the molten metal is set to a temperature as low as possible.

### (Rolling Process)

Next, a hot-rolling is applied to the ingot of copper alloy, thereby, for example, a rolled material having an outer diameter of 8 mm is formed. It is preferable that the hot-rolling at the time of forming the rolled material is carried out at a temperature (550 to 880 degrees C.) lower than a normal temperature (600 to 950 degrees C.). By the hot-rolling, dislocation is introduced into the copper alloy constituting the rolled material so as to accelerate deposition of sulfur as the inevitable impurity on the dislocation. In addition, at the same time, by using the crystallized products dispersed in the copper alloy constituting the rolled material as nuclei, the deposition of sulfur to the nuclei is accelerated. Thereby, the inevitable impurities contained in the copper alloy can be further reduced. For example, the content of sulfur can be reduced in a range of not less than 3 mass ppm and not more than 12 mass ppm, and the content of oxygen can be reduced in a range of more than 2 mass ppm and not more than 30 mass ppm. Further, in the invention, for the purpose of further reducing a solid solubility limit, it is preferable that the temperature of the hot-rolling is set to not more than 880 degrees C. in the first rolling roll, and is set to not less than 550 degrees C. in the last rolling roll. The reason why the temperature is set to not less than 550 degrees C. in the last rolling roll is because if the temperature is less than 550 degrees C., the scratch on wire rod obtained is increased, thus there is a risk that the copper conductor manufactured cannot be treated as a product. By adopting the above-mentioned set temperature, the matrix of copper alloy is enhanced in purity, so that electric conductivity can be enhanced and hardness can be reduced.

Further, in the invention, in the process until the rolling material is fabricated, a continuous casting-rolling method can be used. At this time, it is preferable that copper (pure copper) as a base material is melted in a shaft furnace, and then it is poured into a pail in a reduced state. Namely, it is preferable that the wire rod is stably manufactured by carrying out the casting while controlling the concentration of sulfur, titanium and oxygen and simultaneously applying the rolling work to the material under a reducing gas (CO gas) atmosphere.

### (Wire Drawing Process)

Next, the rolled material is inserted into a wire drawing dice so as to be wire-drawn. The wire drawing dice includes an introduction part, a wire drawing part that has a diameter smaller than the introduction part and an outlet part. The rolled material is introduced into the wire drawing dice from the introduction part thereof, and is processed to have an outer diameter smaller than an outer diameter before the wire drawing in the wire drawing part so as to be drawn out from the outlet part. In the embodiment, the rolled material is wire-drawn via a plurality of paths by using a plurality of the wire drawing dices, thereby the outer diameter of the rolled material is sequentially reduced so as to form a drawn wire material. In particular, a rolled material having an outer diameter of 8 mm is reduced in diameter by a plurality of the wire drawing dices, for example, so as to form a drawn wire material having an outer diameter of 0.1 mm. The drawn wire material obtained has a crystal structure that the crystal grain is elongated in the extension direction because of tensile deformation due to the wire drawing.

In the wire drawing process, the processing degree when the rolled material is wire-drawn so as to form the drawn wire material is controlled to preferably not less than 80%, and more preferably not less than 90% and not more than 99.9%. In case that the processing degree is heightened, breaking of wire occurs when the rolled material is wire-drawn, thus an intermediate heat treatment may be appropriately carried out. Further, the processing degree means a ratio of the cross section of the drawn wire material (the copper alloy after the wire drawing) to the cross section of the rolled material (the copper alloy before the wire drawing). In case that the rolled material is wire-drawn via a plurality of paths by using a plurality of the wire drawing dices, it is preferable that the processing degree in each of the wire drawing dices is adjusted in a manner such that the processing degree falls within the above-mentioned range.

In the rolled material to which the wire drawing process is applied, the crystallized products generated when the above-mentioned molten metal of the copper alloy is formed are dispersed. The crystallized products inhibit crystal growth due to recrystallization of the crystal grain in a recrystallization process described below and have an action that prevents the crystal grain from being increased in the grain size. In the embodiment, the wire drawing processing is applied to the rolled material including the crystallized products in a high processing degree of not less than 80% in the wire drawing process, thereby the drawn wire material is formed. The drawn wire material formed in the high processing degree is configured such that the crystallized products are distributed in the outer periphery region more than in the center region. Namely, the drawn wire material is formed such that the concentration of the crystallized products is heightened in the outer periphery region more than in the center region. In the above-mentioned drawn wire material, at the time of recrystallization, the crystal grains distributed in the center region have the crystallized products low in the concentration, thus the crystal grains are easily crystal-grown. On the other hand, the crystal grains distributed in the outer periphery region have the crystallized products high in the concentration, thus the crystal grains are hardly crystal-grown. For this reason, at the time of recrystallization, the crystal grains distributed in the center region are easily increased in size, but the crystal grains distributed in the outer periphery region are hardly increased in size.

### (Recrystallization Process)

Next, the drawn wire material is heated (annealed) so as to recrystallize the crystal structure of the copper alloy constituting the drawn wire material, thereby the conductor 10 having an outer diameter of 0.1 mm is formed. The copper alloy constituting the drawn wire material is heated, thereby the crystal structure thereof is recrystallized. By recrystallization, the crystal grain in the copper alloy is crystal-grown, so that the grain size of the crystal grain is increased. As a result, in the conductor 10, the grain size of the crystal grain is increased in comparison with the drawn wire material. However, as described above, the drawn wire material is formed such that the concentration of the crystallized products is higher in the outer periphery region 14 than in the center region 13, thus an increase in the grain size of the crystal grain due to the crystal growth is different depending on the region. Namely, in the center region 13 where the concentration of the crystallized products is low, the crystal grain is easily crystal-grown, thus the crystal grain (the first crystal grain group 11) having relatively large grain size is formed. On the other hand, in the second crystal grain group 12 where the concentration of the crystallized products is high, the crystal grain is hardly crystal-grown, thus the crystal grain (the second crystal grain group 12) having relatively small grain size is formed. As a result, as shown in FIG. 1B, the conductor 10 has the crystal structure configured such that the first crystal grain group 11 that is constituted of crystal grains having relatively large grain size is distributed in the center region 13, and the second crystal grain group 12 that is constituted of crystal grains having relatively small grain size is distributed in the outer periphery region 14. Further, it is preferable that the heat temperature of the recrystallization is set to, for example, not less than 200 degrees C. and not more than 600 degrees C. In addition, it is preferable that a heating time is set to, for example, not less than 10 seconds and not more than 1 hour.

### Advantageous Effects of the Embodiment

According to the embodiment, one or a plurality of advantageous effects as described below is (are) provided.
(a) According to the embodiment, the conductor 10 is comprised of the copper alloys, the crystal grains constituting the copper alloy include the first crystal grain group 11 that is constituted of crystal grains having a grain size larger than a predetermined standard grain size and the second crystal grain group 12 that is constituted of crystal grains having a grain size smaller than the predetermined standard grain size, and has the maximum value of grain size distribution in each of the first crystal grain group 11 and the second crystal grain group 12. Namely, the conductor 10 is mainly configured such that the first crystal grain group 11 that is constituted of crystal grains having a relatively large grain size and the second crystal grain group 12 that is constituted of crystal grains having a relative small grain size are mixed. According to the first crystal grain group 11, the crystal grain boundary in the conductor 10 is reduced, thus the electric conductivity of conductor 10 can be enhanced. On the other hand, according to the second crystal grain group 12, the crystal grain boundary in the conductor 10 is increased, thus processing strain in the conductor 10 is dispersed, so that the strength of the conductor 10 can be enhanced. Consequently, according to the conductor 10 of the embodiment, the first crystal grain group 11 and the second crystal grain group 12 are included, thereby both high electric conductivity and high strength can be realized.
(b) According to the embodiment, the grain size distribution of the first crystal grain group 11 has the maximum value preferably in a region of not less than 20 μm and more preferably in a region of not less than 25 μm and not more than 100 μm, and the grain size distribution of the second crystal grain group 12 has the maximum value preferably in a region of not more than 15 μm, and more preferably in a region of not less than 3 μm and not more than 10 μm. Thereby, the electric conductivity and the strength obtained by each of the crystal grain groups can be further enhanced.
(c) According to the embodiment, the total value of the maximum value of the grain size distribution of the first crystal grain group 11 and the maximum value of the grain size distribution of the second crystal grain group 12 is preferably not less than 50%, and more preferably not less than 60% and not more than 90%. The more the total value of the maximum value is high, the more the total of the number ratio of first crystal grain 11a constituting the peak P1 of the first crystal grain group 11 and the number ratio of second crystal grain 12a constituting the peak P2 of the second crystal grain group 12 is increased. Namely, the ratio of the first crystal grain 11a and the number ratio of the second crystal grain 12a to the whole crystal grains included in the conductor 10 can be enhanced. Thereby, the number ratio of crystal grains different from the first crystal grain 11a and the second crystal grain 12a in grain size, for example, the number ratio of the other crystal grains having a grain size intermediate between the first crystal grain 11a and the second crystal grain 12a can be reduced. Consequently, the electric conductivity and the strength obtained by each of the crystal grain groups can be further enhanced.
(d) According to the embodiment, the maximum value of the grain size distribution of the first crystal grain group 11 is preferably not less than 10% and not more than 40%, and the maximum value of the grain size distribution of the second crystal grain group 12 is preferably not less than 40% and not more than 90%. Thereby, the total value of the maximum value of the grain size distribution of these grain groups can be set to not less than 50%, and the electric conductivity and the strength obtained by each of the crystal grain groups can be further enhanced.
(e) According to the embodiment, a difference between the grain size at which the grain size distribution of the first crystal grain group 11 becomes the maximum value and the grain size at which the grain size distribution of the second crystal grain group 12 becomes the maximum value is preferably not less than 5 μm and not more than 75 μm. Thereby, a difference between the grain sizes of the crystal grain groups in the crystal structure of the copper alloy constituting the conductor 10 is increased, thus the electric conductivity and the strength obtained by each of the crystal grain groups can be further enhanced.
(f) According to the embodiment, in the conductor 10, it is preferable that the first crystal grain group 11 that is constituted of crystal grains having a large grain size is distributed in the center region 13 and the second crystal grain group 12 that is constituted of crystal grains having a small grain size is distributed in the outer periphery region 14 surrounding the center region 13. The center region 13 is constituted of the first crystal grain group 11 that is constituted of crystal grains having a large grain size, thus the crystal grain boundary is relatively small in number. On the other hand, the outer periphery region 14 is constituted of the second crystal grain group 12 that is constituted of crystal grains having a small grain size, thus the crystal grain boundary is relatively large in number. As mentioned above, the conductor 10 is configured such that in the center region 13, the crystal grain boundary is relatively small in number, and in the outer periphery region 14, the crystal grain boundary is relatively large in number. The more the crystal grain boundary is large in number, the more the electric signal is easily attenuated, thus in the conductor 10, in the center region 13 (inner part), attenuation in the electric signal is reduced, and in the outer periphery region 14 (front surface), attenuation in the electric signal is increased. The above-mentioned conductor 10 is used in the acoustic device cable 1, thereby the sound quality of the acoustic device cable 1 can be further enhanced. Hereinafter, this point will be explained in particular.

Generally, an electric signal having a frequency band from lower register to upper register is transmitted through the conductor of the acoustic device cable. The electric signal is transmitted through the difference region of the conductor according to the difference of the frequency. Namely, the electric signal of lower frequency (lower register) is transmitted through the whole of conductor, but is intensively transmitted through the inner part (center region) of the conductor having lower resistance. On the other hand, the electric signal of higher frequency (higher register) is intensively transmitted through the front surface (outer periphery region) of the conductor due to skin effect. In case that the electric signal is transmitted through the above-mentioned conductor 10, the electric signal of lower frequency (lower register) of the electric signals is transmitted through the center region 13 in which the crystal grain boundary is small in number, thus it is hardly attenuated. On the other hand, the electric signal of higher frequency (higher register) is transmitted through the outer periphery region 14 in which the crystal grain boundary is relatively large in number, thus it is extremely attenuated. Namely, according to the above-mentioned conductor 10, the electric signal of higher register of the electric signals is attenuated so that filtering can be carried out. Consequently, the above-mentioned conductor 10 is used for the acoustic device cable 1, thereby filtering is carried out so that it can balance the higher register and the lower register difficult to hear in comparison with the higher register.
(g) According to the embodiment, the acoustic device cable 1 includes the above-mentioned conductor 10, the insulating coating 30 disposed on the outer periphery of the conductor 10, and the protective covering 40 disposed on the outer periphery of the insulating coating 30. The acoustic device cable 1 includes the conductor 10 having high electric conductivity and high strength, thus it is excellent in sound quality when the electric signal transmitted is output, and further it hardly causes breaking of wire. Furthermore, according to the acoustic device cable 1, filtering is applied to the higher register, thereby balance between the higher register and the lower register can be adjusted.

### Other Embodiments

In the above-mentioned embodiment, FIG. 2 is shown as one example of the grain size distribution of the conductor 10, but the invention is not particularly limited to this. FIG. 2 shows the grain size distribution configured such that the maximum value of the second crystal grain group 12 is higher than that of the first crystal grain group 11, and the number ratio of the second crystal grain group 12 that enhances the strength is relatively large. In this case, in the conductor 10, the strength can be relatively enhanced. In the invention, the number ratio of the first crystal grain group 11 and the second crystal grain group 12 can be appropriately changed, for example, the grain size distribution shown in FIG. 3 can be adopted. In case of FIG. 3, the number ratio of the first crystal grain group 11 that enhances the electric conductivity is relatively large, and in the conductor 10, the electric conductivity can be relatively enhanced. As described above, in the invention, in the conductor 10, the number ratio of the first crystal grain group 11 and the second crystal grain group 12 is adjusted, thereby the electric conductivity and the strength can be controlled. For example, the ratio of the maximum value of the grain size distribution of the first crystal grain group 11 to the maximum value of the grain size distribution of the second crystal grain group 12 can be appropriately changed in the range of 1:9 to 5:4.

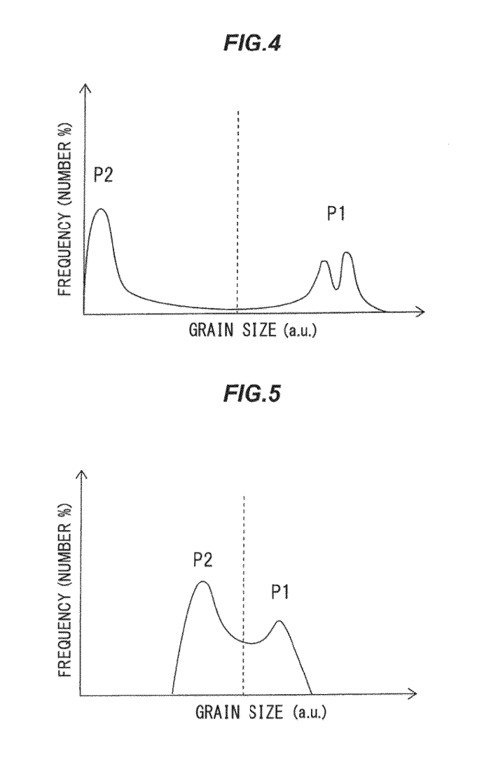

In addition, FIG. 2 shows a configuration that each of the first crystal grain group 11 and the second crystal grain group 12 has one maximum value of the grain size distribution, but the number of the maximum value is not particularly limited thereto. For example, as shown in FIG. 4, the first crystal grain group 11 may have two maximum values.

In addition, FIG. 2 shows a configuration that a difference between the maximum value of the grain size distribution of the first crystal grain group 11 and the maximum value of the grain size distribution of the second crystal grain group 12 is large, but as shown in FIG. 5, a difference between the respective maximum values is small, and the peaks of the respective crystal grain groups may be partially overlapped with each other. In the invention, if the first crystal grain group 11 and the second crystal grain group 12 are mainly included and these crystal grain groups are mixed, both high electric conductivity and high strength of the conductor 10 can be realized.

In addition, in the above-mentioned embodiment, a configuration that the predetermined standard grain size is the center value of the minimum grain size and the maximum grain size of the crystal grains has been explained, but the predetermined standard grain size can be appropriately changed according to characteristics (electric conductivity and strength) required for the conductor. For example, the predetermined standard grain size that is larger than the center value is adopted, thereby the electric conductivity of the conductor 10 can be enhanced. On the other hand, the predetermined standard grain size that is smaller than the center value is adopted, thereby the strength of the conductor 10 can be enhanced.

In addition, in the above-mentioned embodiment, a configuration that the first crystal grain group 11 that is constituted of crystal grains having relative large grain size is distributed in the center region 13 and the second crystal grain group 12 that is constituted of crystal grains having relative small grain size is distributed in the outer periphery region 14 has been explained, but the distribution of the crystal grain is not particularly limited to this. For example, the distribution of the first crystal grain group 11 and the second crystal grain group 12 may be inverted from the above-mentioned distribution. Namely, the conductor 10 may have a crystal structure configured such that the first crystal grain group 11 is distributed in the outer periphery region 14 and the second crystal grain group 12 is distributed in the center region 13. According to the above-mentioned conductor 10, the electric signal of lower frequency is attenuated so as to be transmitted, on the other hand the electric signal of upper frequency can be transmitted without extremely causing loss due to attenuation. Consequently, the conductor 10 can apply filtering to the lower register when it is used for the acoustic device cable 1.

In addition, in the above-mentioned embodiment, a configuration that the transverse section of the conductor 10 has a circular shape has been explained, but the transverse section thereof may have, for example, a rectangular shape.

In addition, in the above-mentioned embodiment, a configuration of a stranded conductor that is formed by twisting together a plurality of the conductors 10 of the invention has been explained, but a configuration that the conductor 10 of the invention is combined with the other general purpose conductor may be adopted. In addition, in the above-mentioned embodiment, a configuration of the stranded conductor that is formed by twisting together a plurality of the conductors 10 has been explained, but one conductor 10 may be used.

In addition, in the above-mentioned embodiment, a configuration that the conductors 10 is used for the acoustic device cable 1 has been explained, but the invention is not particularly limited to this, for example, the conductor 10 may be used for a video device cable. Furthermore, it may be also used for an electric wire.

### <Preferable Features of the Invention>

The preferable features of the invention will be noted below.

### [Feature 1]

According to one feature of the invention, a conductor comprises a copper alloy comprising crystal grains,

wherein the crystal grains comprise a first crystal grain group that is constituted of crystal grains having a grain size larger than a predetermined standard grain size and a second crystal grain group that is constituted of crystal grains having a grain size smaller than the predetermined standard grain size, and

wherein the crystal grains have a local maximum value of grain size distribution in each of the first crystal grain group and the second crystal grain group.

### [Feature 2]

The conductor according to the feature 1 is preferably configured such that the grain size distribution of the first crystal grain group has the local maximum value in a region of grain size of not less than 20 μm and the grain size distribution of the second crystal grain group has the local maximum value in a range of grain size of not more than 15 μm.

### [Feature 3]

The conductor according to the feature 1 or 2 is preferably configured such that the total value of the local maximum value of the grain size distribution of the first crystal grain group and the local maximum value of the grain size distribution of the second crystal grain group is not less than 50%.

### [Feature 4]

The conductor according to the feature 3 is preferably configured such that the local maximum value of the grain size distribution of the first crystal grain group is not less than 10% and the local maximum value of the grain size distribution of the second crystal grain group is not less than 40%.

### [Feature 5]

The conductor according to any one of the features 1 to 4 is preferably configured such that the conductor is formed by being linearly extended, and in a cross section perpendicular to the extended direction, the first crystal grain group is distributed at a center region in a diameter direction of the cross section, and the second crystal grain group is distributed at an outer periphery region surrounding the center region.

### [Feature 6]

The conductor according to the feature 5 is preferably configured such that the copper alloy comprises an impurity and a concentration of the impurity at the outer periphery region is higher than a concentration of the impurity at the center region.

### [Feature 7]

According to another feature of the invention, an electric wire comprises:

the conductor according to any one of the features 1 to 6; and

an insulating coating formed on an outer periphery of the conductor.

### [Feature 8]

According to another feature of the invention, a cable comprises:

the conductor according to any one of the features 1 to 6;

an insulating coating formed on an outer periphery of the conductor; and

a protective covering formed on an outer periphery of the insulating coating.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A conductor, comprising a copper alloy comprising crystal grains,
wherein the crystal grains comprise a first crystal grain group having a grain size larger than a predetermined standard grain size and a second crystal grain group having a grain size smaller than the predetermined standard grain size, and
wherein the crystal grains have a local maximum value of grain size distribution in each of the first crystal grain group and the second crystal grain group.

2. The conductor according to claim 1, wherein the grain size distribution of the first crystal grain group has the local maximum value in a region of grain size of not less than 20 μm, and
wherein the grain size distribution of the second crystal grain group has the local maximum value in a range of grain size of not more than 15 μm.

3. The conductor according to claim 1, wherein a total value of the local maximum value of the grain size distribution of the first crystal grain group and the local maximum value of the grain size distribution of the second crystal grain group is not less than 50%.

4. The conductor according to claim 3, wherein the local maximum value of the grain size distribution of the first crystal grain group is not less than 10%, and
wherein the local maximum value of the grain size distribution of the second crystal grain group is not less than 40%.

5. The conductor according to claim 1, wherein the conductor is formed by being linearly extended,
wherein in a cross section perpendicular to the extended direction, the first crystal grain group is distributed at a center region in a diameter direction of the cross section, and
wherein the second crystal grain group is distributed at an outer periphery region surrounding the center region.

6. The conductor according to claim 5, wherein the copper alloy further comprises an impurity, and
wherein a concentration of the impurity at the outer periphery region is higher than a concentration of the impurity at the center region.

7. An electric wire, comprising:
the conductor according to claim 1; and
an insulating coating formed on an outer periphery of the conductor.

8. A cable, comprising:
the conductor according to claim 1;
an insulating coating formed on an outer periphery of the conductor; and
a protective covering formed on an outer periphery of the insulating coating.
